(19) United States
(12) Patent Application Publication
(10) Pub. No.: US 2009/0005115 A1
(43) Pub. Date: Jan. 1, 2009

(54) Wireless Fax Module And System

(76) Inventors: Yan Po Chan, Lexington, KY (US); Marvin Nicholson, III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/768,436

(22) Filed: Jun. 26, 2007

(51) Int. Cl. H04B 1/38

(52) U.S. Cl. 455/557

(57) ABSTRACT

An electronic module for facilitating wireless facsimile data transfer between an external machine and a telephone line outlet includes a phone line interface configured for connection to the telephone line outlet. An analog fax modem is configured to both transmit outgoing facsimile data and receive incoming facsimile data via the phone line interface. A wireless transceiver is configured to wirelessly transmit the incoming facsimile data to the external machine and is configured to wirelessly receive the outgoing facsimile data from the external machine. A routing device is communicatively coupled to each of the analog fax modem and the wireless transceiver. The routing device is configured to route the incoming facsimile data within the electronic module from the analog fax modem to the wireless transceiver, and is configured to route the outgoing facsimile data within the electronic module from the wireless transceiver to the analog fax modem.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to facsimile machines, and more particularly to a wireless fax module and system.

2. Description of the Related Art

In prior art, with the advent of wireless data communication, e.g., Wi-Fi (IEEE 802.11a/b/g), an All-In-One (AIO) machine having scanning, faxing (generation and/or transmission of facsimile data) and printing capabilities have been able to be detached from other home office components, such as a personal computer. Although an AIO machine may contain wireless data links, the fax link is facilitated by a physical, i.e., mechanical, link to a telephone line outlet by way of a telephone cable. This arrangement for facilitating fax functionality restricts the placement of the AIO in a home or office environment such that the AIO must reside near the telephone line outlet if the fax function for the AIO is to be used. This places a restriction on the potential “anywhere” placement of an AIO machine.

Wireless phone jacks are available that use AC outlets as the conduit to carry converted analog phone signals to and from transceiver pairs. However, such a system results in poor signal quality for high speed data transfer, and thus is not suitable for high speed data transfer that adequately and reliably accommodates the transfer of facsimile data.

### SUMMARY OF THE INVENTION

The invention, in one form thereof, is directed to an electronic module for facilitating wireless facsimile data transfer between an external machine and a telephone line outlet. The electronic module includes a phone line interface configured for connection to the telephone line outlet. An analog fax modem has a port communicatively coupled to the phone line interface. The analog fax modem is configured to both transmit outgoing facsimile data and receive incoming facsimile data via the phone line interface. A wireless transceiver is configured to wirelessly transmit the incoming facsimile data to the external machine and is configured to wirelessly receive the outgoing facsimile data from the external machine. A routing device is communicatively coupled to each of the analog fax modem and the wireless transceiver. The routing device is configured to route the incoming facsimile data within the electronic module from the analog fax modem to the wireless transceiver, and is configured to route the outgoing facsimile data within the electronic module from the wireless transceiver to the analog fax modem.

The invention, in another form thereof, is directed to a wireless fax module for facilitating wireless facsimile data transfer between an external machine and a telephone line outlet. The wireless fax module includes a phone line interface configured for connection to the telephone line outlet. An analog fax modem has a port communicatively coupled to the phone line interface. The analog fax modem is configured to both transmit outgoing facsimile data and receive incoming facsimile data via the phone line interface. A wireless transceiver is configured to wirelessly transmit the incoming facsimile data to the external machine and is configured to wirelessly receive the outgoing facsimile data from the external machine. A controller is communicatively coupled to each of the analog fax modem and the wireless transceiver. The controller executes program instructions for routing the incoming facsimile data within the wireless fax module from the analog fax modem to the wireless transceiver, and for routing the outgoing facsimile data within the wireless fax module from the wireless transceiver to the analog fax modem.

The invention, in another form thereof, is directed to a wireless facsimile system. The wireless facsimile system includes an external machine having a data processing unit, and a first wireless transceiver communicatively coupled to the data processing unit. A wireless fax module facilitates wireless facsimile data transfer between the external machine and a telephone line outlet. The wireless fax module includes a phone line interface configured for connection to the telephone line outlet. An analog fax modem has a port communicatively coupled to the phone line interface. The analog fax modem is configured to both transmit outgoing facsimile data and receive incoming facsimile data via the phone line interface. A second wireless transceiver is configured to wirelessly transmit the incoming facsimile data to the external machine and is configured to wirelessly receive the outgoing facsimile data from the external machine. A routing device is communicatively coupled to each of the analog fax modem and the second wireless transceiver. The routing device is configured to route the incoming facsimile data within the wireless fax module from the analog fax modem to the second wireless transceiver, and is configured to route the outgoing facsimile data within the wireless fax module from the second wireless transceiver to the analog fax modem.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is diagrammatic illustration of a facsimile system configured in accordance with an embodiment of the present invention; and

FIG. 2 is a block diagram of the wireless fax module used in the facsimile system of FIG. 1.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, some aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and other alternative mechanical configurations are possible.

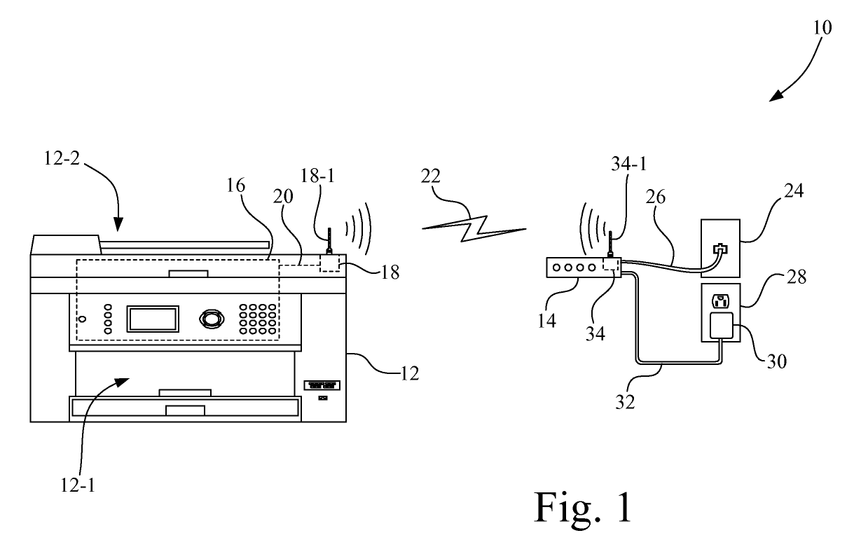

Referring to FIG. 1, there is shown a facsimile system 10 configured in accordance with an embodiment of the present invention. Facsimile system 10 includes an external machine 12 and a wireless fax module 14.

External machine 12 includes a data processing unit 16 and a wireless transceiver 18 having an associated antenna 18-1. External machine 12 may be, for example, an All-In-One (AIO) machine that is configured with a printer 12-1 to facilitate printing of documents and configured with a scanner 12-2 to facilitate scanning of documents, and to facilitate faxing operations when used in conjunction with wireless fax module 14. Data processing unit 16 is connected to wireless transceiver 18 via a communication link 20, such as a serial or parallel interface, to facilitate data transfer between data processing unit 16 and wireless transceiver 18. Printer 12-1 and scanner 12-2 may form a portion of data processing unit 16. Wireless transceiver 18 is configured to facilitate wireless data communication between external machine 12 and wireless fax module 14 using a standard wireless communication protocol 22, such as for example, IEEE 802.11 b/g.

Wireless fax module 14 is physically connected to a telephone line outlet 24 via a phone line 26, and is physically connected to an alternating current (AC) outlet 28 via a power transformer device 30. Power transformer device 30 provides electrical power to the various electronic components in wireless fax module 14 via a power cable 32. Wireless fax module 14 includes a wireless transceiver 34 having an associated antenna 34-1. Wireless transceiver 34 of wireless fax module 14 is configured to facilitate wireless data communication either another wireless transceiver, such as wireless transceiver 18 of external machine 12, using the predefined standard wireless communication protocol 22, e.g., IEEE 802.11 b/g. For example, wireless transceiver 34 of wireless fax module 14 is configured to wirelessly transmit incoming facsimile data to external machine 12, and is configured to wirelessly receive outgoing facsimile data from external machine 12.

Wireless fax module 14 is configured to operate in either of infrastructure or ad-hoc wireless network modes. For example, external machine 12 having wireless capability is configured to recognize, support, and link to wireless fax module 14. Once the wireless link is established, external machine 12 interacts with wireless fax module 14 as though the stand alone wireless fax module 14 is hardwired or internally connected to external machine 12.

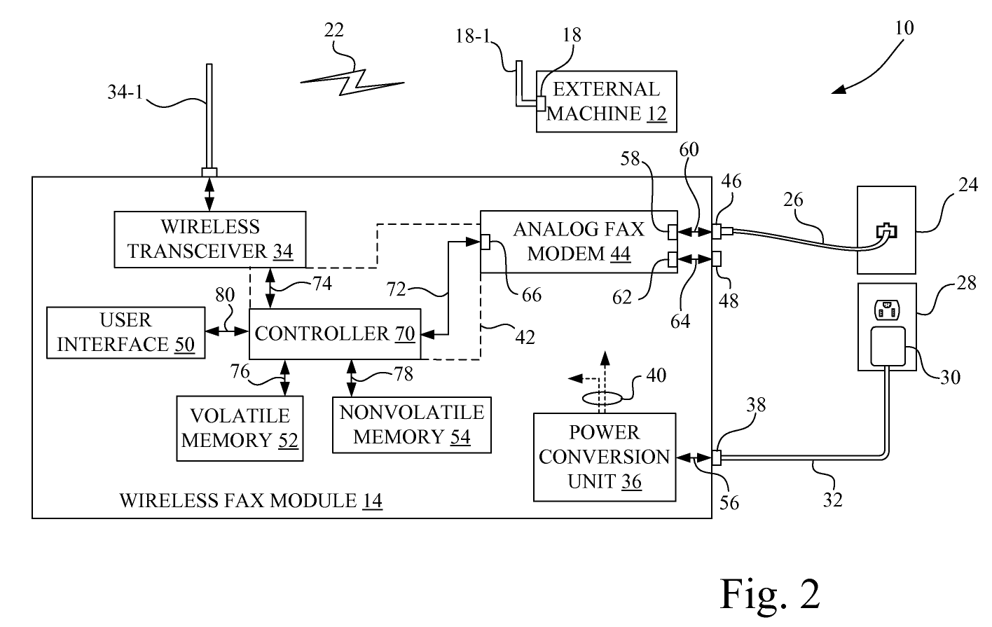

Referring also to FIG. 2, wireless fax module 14 further includes a power conversion unit 36, a power interface 38, a power bus 40, a routing device 42, an analog fax modem 44, a phone line interface 46, an auxiliary phone interface 48, a user interface 50, volatile memory 52, and nonvolatile memory 54.

Power conversion unit 36 converts an AC voltage from power transformer device 30 to a regulated DC voltage for use by the components of wireless fax module 14. For example, power conversion unit 36 may supply regulated DC voltages via power bus 40 to wireless transceiver 34, routing device 42, analog fax modem 44, user interface 50, volatile memory 52, and nonvolatile memory 54. Power conversion unit 36 is electrically connected to power interface 38 via conductors 56, and in turn power interface 38 is connected to power transformer device 30 via power cable 32.

Analog fax modem 44 is configured to both transmit the outgoing facsimile data and receive the incoming facsimile data via phone line interface 46, which in turn is physically connected to telephone line outlet 24 via phone line 26. Analog fax modem 44 has a first port 58 that is communicatively coupled to phone line interface 46 via a communication link 60. Analog fax modem 44 has a second port 62 that is communicatively coupled to auxiliary phone interface 48 via a communication link 64. Each of phone line interface 46 and auxiliary phone interface 48 may be, for example, an RJ11 phone line jack. Each of communication links 60, 64 may be, for example, electrical conductors, such as wires or a bus structure. Analog fax modem 44 has a third port 66 that is communicatively coupled to routing device 42.

Auxiliary phone interface 48 may be in the form of an extension jack to provide a series connection which will allow the use of a telephone down stream of the stand alone wireless fax module 14. Accordingly, a user may utilize telephone line outlet 24 for making voice calls in the alternative to using telephone line outlet 24 during a facsimile operation.

Routing device 42 is communicatively coupled to each of analog fax modem 44 and wireless transceiver 34. Routing device 42 is configured to physically route the incoming facsimile data within wireless fax module 14 from analog fax modem 44 to wireless transceiver 34, and is configured to physically route outgoing facsimile data within wireless fax module 14 from wireless transceiver 34 to analog fax modem 44. Routing device 42 may include, for example, a controller 70, a first wired interface 72, and a second wired interface 74.

Controller 70 may include a processor and associated memory, and may be formed as an Application Specific Integrated Circuit (ASIC). First wired interface 72 is connected between controller 70 and third port 66 of analog fax modem 44. First wired interface 72 may be, for example, a serial interface or a parallel interface. Second wired interface 74 is connected between controller 70 and wireless transceiver 34. Second wired interface 74 may be, for example, a universal serial bus or a Peripheral Component Interconnect (PCI) interface.

Controller 70 may be configured, for example, by way of the execution of program instructions. For example, controller 70 may execute program instructions to route incoming facsimile data within wireless fax module 14 from analog fax modem 44 to wireless transceiver 34, and to route outgoing facsimile data within wireless fax module from wireless transceiver 34 to analog fax modem 44.

Controller 70 is communicatively coupled to volatile memory 52 via a communication link 76 and is communicatively coupled to nonvolatile memory 54 via a communication link 78. Volatile memory 52 and/or nonvolatile memory 54 may be formed separate from controller 70, or alternatively, volatile memory 52 and/or nonvolatile memory 54 may be formed integral with controller 70 in the ASIC. Controller 70 communicates with user interface 50 by way of a communication link 80. Communication links 76, 78 and 80 may be established, for example, by using standard electrical cabling or bus structures.

Incoming facsimile data and outgoing facsimile data may be buffered in volatile memory 52 by controller 70 during a facsimile receive operation and a facsimile transmission operation, respectively. Volatile memory 52 may be, for example, random access memory (RAM). Nonvolatile memory, e.g., flash memory, may be accessed by controller 70 to store or retrieve control data, e.g., default selections or default override settings, used in operating wireless fax module 14, such as for example, the settings for analog fax modem 44 and/or wireless transceiver 34.

User interface 50 is configured to provide an operating status of electronic wireless fax module 14, and is configured to facilitate a user input to wireless fax module 14. Operating status may be indicated to a user, for example, via one or more indicator lights, or an LCD display. User input may be provided, for example, by one or more push buttons. User interface 50 may facilitate a local setup of wireless fax module 14, such as for example, during the setup configuration of analog fax modem 44 and/or wireless transceiver 34. The setup configuration data may include, for example, default selections for a default fax mode, or default override selections. Such default selections or default override selections may include, for example, a color/monochrome selection, a baud rate selection, and a fax quality selection. The default selections and/or default override selections may be stored, for example, in nonvolatile memory 54. Other setup configuration data may include, for example, the time and date, the number of rings before answering, etc.

Alternatively, the setup configuration of wireless fax module 14 may be made remotely via an internet protocol (IP) address and an internal configuration web page with the aid of program instructions executed by controller 70. In one embodiment, controller 70 of wireless fax module 14 may contain a web server to facilitate the remote configuration of wireless fax module 14 via a web page. The web server may be implemented as program instructions executed by controller 70. For example, a computer (serving as external machine 12) may establish a wireless link to wireless fax module 14, and through access to the setup support available at a predetermined web page, default selections may be made and stored in nonvolatile memory 54 of wireless fax module 14.

For a fax transmission operation, external machine 12 wirelessly sends default override data (if any), the fax transmit phone number, and the outgoing facsimile data to wireless fax module 14. The default override data may include, for example, fax modem settings that are different from the default fax mode, e.g., color/mono, baud rate, fax quality. The outgoing facsimile data, i.e., fax image information, may be generated, for example, by scanner 12-2 of external machine 12. The outgoing facsimile data is in a predefined format, such as for example, joint photographic experts group compression format (JPEG) for color fax images, or Modified Huffman (MH), Modified READ (MR) and Modified Modified READ (MMR) compression for monochrome fax images.

For a fax receive operation, wireless fax module 14 may receive and process the incoming facsimile data as follows. Upon receipt, the incoming facsimile data is stored in onboard volatile memory 52 for later retrieval or for fax forwarding. At the desired time, the received incoming facsimile data is transmitted via wireless transceiver 34 to external machine 12, or other machine, which is connected as the default recipient or endpoint of incoming faxes received by wireless fax module 14. Data processing unit 16 of external machine 12 then processes the incoming facsimile data as if external machine 12 is receiving a wireless print job.

Alternatively, wireless fax module 14 may operate in a broadcast mode to transmit the received incoming facsimile data wirelessly to all external machines, such as for example, multiple AIO machines, which are wirelessly linked to wireless fax module 14. Each individual wirelessly linked external machine may then process the incoming facsimile data as if it is receiving a wireless print job.

The foregoing description of methods and embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An electronic module for facilitating wireless facsimile data transfer between an external machine and a telephone line outlet, comprising:
a phone line interface configured for connection to said telephone line outlet;
an analog fax modem having a port communicatively coupled to said phone line interface, said analog fax modem being configured to both transmit outgoing facsimile data and receive incoming facsimile data via said phone line interface;
a wireless transceiver configured to wirelessly transmit said incoming facsimile data to said external machine and configured to wirelessly receive said outgoing facsimile data from said external machine; and
a routing device communicatively coupled to each of said analog fax modem and said wireless transceiver, said routing device being configured to route said incoming facsimile data within said electronic module from said analog fax modem to said wireless transceiver, and being configured to route said outgoing facsimile data within said electronic module from said wireless transceiver to said analog fax modem.

2. The electronic module of claim 1, wherein said routing device includes:
a controller;
a first wired interface connected between said controller and said analog fax modem; and
a second wired interface connected between said controller and said wireless transceiver.

3. The electronic module of claim 2, wherein said first interface is one of a serial interface and a parallel interface.

4. The electronic module of claim 2, wherein said second interface is one of a universal serial bus and a PCI interface.

5. The electronic module of claim 2, further comprising a user interface coupled to said controller, said user interface being configured to provide an operating status of said electronic module, and being configured to facilitate a user input to said electronic module.

6. The electronic module of claim 2, further comprising a volatile memory coupled to said controller, said controller accessing said volatile memory to buffer one of said incoming facsimile data and said outgoing facsimile data during a facsimile operation.

7. The electronic module of claim 2, further comprising a nonvolatile memory coupled to said controller, said controller accessing said nonvolatile memory to store or retrieve setup configuration data used in operating said electronic module.

8. A wireless fax module for facilitating wireless facsimile data transfer between an external machine and a telephone line outlet, comprising:
a phone line interface configured for connection to said telephone line outlet;
an analog fax modem having a port communicatively coupled to said phone line interface, said analog fax modem being configured to both transmit outgoing facsimile data and receive incoming facsimile data via said phone line interface;
a wireless transceiver configured to wirelessly transmit said incoming facsimile data to said external machine and configured to wirelessly receive said outgoing facsimile data from said external machine; and
a controller communicatively coupled to each of said analog fax modem and said wireless transceiver, said controller executing program instructions for:
routing said incoming facsimile data within said wireless fax module from said analog fax modem to said wireless transceiver, and
routing said outgoing facsimile data within said wireless fax module from said wireless transceiver to said analog fax modem.

9. The wireless fax module of claim 8, said controller executing program instructions for implementing a web server to facilitate a remote configuration of said wireless fax module.

10. The wireless fax module of claim 8, further comprising a user interface coupled to said controller, said user interface being configured to provide an operating status of said wireless fax module, and being configured to facilitate a user input to said wireless fax module.

11. The wireless fax module of claim 8, further comprising a volatile memory coupled to said controller, said controller executing program instructions for accessing said volatile memory to buffer one of said incoming facsimile data and said outgoing facsimile data during a facsimile operation.

12. The wireless fax module of claim 8, further comprising a nonvolatile memory coupled to said controller, said controller accessing said nonvolatile memory to store or retrieve setup configuration data used in operating said wireless fax module.

13. A wireless facsimile system, comprising:
an external machine having a data processing unit, and a first wireless transceiver communicatively coupled to said data processing unit; and
a wireless fax module for facilitating wireless facsimile data transfer between said external machine and a telephone line outlet, said wireless fax module including:
a phone line interface configured for connection to said telephone line outlet;
an analog fax modem having a port communicatively coupled to said phone line interface, said analog fax modem being configured to both transmit outgoing facsimile data and receive incoming facsimile data via said phone line interface;
a second wireless transceiver configured to wirelessly transmit said incoming facsimile data to said external machine and configured to wirelessly receive said outgoing facsimile data from said external machine; and
a routing device communicatively coupled to each of said analog fax modem and said second wireless transceiver, said routing device being configured to route said incoming facsimile data within said wireless fax module from said analog fax modem to said second wireless transceiver, and being configured to route said outgoing facsimile data within said wireless fax module from said second wireless transceiver to said analog fax modem.

14. The wireless facsimile system of claim 13, wherein said routing device includes:
a controller;
a first wired interface connected between said controller and said analog fax modem; and
a second wired interface connected between said controller and said second wireless transceiver.

15. The wireless facsimile system of claim 14, wherein said first interface is one of a serial interface and a parallel interface.

16. The wireless facsimile system of claim 14, wherein said second interface is one of a universal serial bus and a PCI interface.

17. The wireless facsimile system of claim 14, said wireless fax module further including a user interface coupled to said controller, said user interface being configured to provide an operating status of said wireless fax module, and being configured to facilitate a user input to said wireless fax module.

18. The wireless facsimile system of claim 14, said wireless fax module further including a volatile memory coupled to said controller, said controller accessing said volatile memory to buffer one of said incoming facsimile data and said outgoing facsimile data during a facsimile operation.

19. The wireless facsimile system of claim 14, said wireless fax module further including a nonvolatile memory coupled to said controller, said controller accessing said nonvolatile memory to store or retrieve setup configuration data used in operating said wireless fax module.

20. The wireless facsimile system of claim 14, wherein said external machine is an All-In-One machine that is configured to facilitate printing and scanning of documents, and to facilitate faxing operations when used in conjunction with said wireless fax module.
